(19) United States
(12) Patent Application Publication
(10) Pub. No.: US 2026/0244524 A1
(43) Pub. Date: Aug. 20, 2026

(54) RESOLVING A HARDWARE FAULT OCCURRENCE IN A MULTI-DOMAIN DEVICE

(71) Applicant: Infineon Technologies AG, Neubiberg (DE)

(72) Inventors: Thiyagu Loganathan, Baldham (DE); Thomas Röcker, München (DE); Jens Rosenbusch, München (DE); Bejoy Mathews, Oberhaching (DE); Benedikt Rest, Seeshaupt (DE); Stephan Stilkerich, Ottobrunn (DE)

(21) Appl. No.: 19/058,173

(22) Filed: Feb. 20, 2025

(51) Int. Cl. G06F 11/07; G06F 11/14

(52) U.S. Cl. CPC G06F 11/079; G06F 11/1438

(57) ABSTRACT

Some aspects of the present disclosure relate to an integrated circuit (IC) device having a root domain and one or more branch domains. Each domain includes a logic circuit, a fault-structure circuit, a power delivery network (PDN) and a clock distribution network (CDN). The PDN of each domain is operable independently of the PDN of the other domains. The CDN of each domain is operable independently of the CDN of the other domains. The fault-structure circuit of each branch domain is configured to: detect a hardware fault occurrence in the branch domain, determine a response to the detected hardware fault occurrence, and escalate the detected hardware fault occurrence to the fault-structure circuit of the root domain in accordance with the determined response. The fault-structure circuit of the root domain is configured to resolve the detected hardware fault occurrence escalated from the branch domain.

### BACKGROUND

Integrated-circuit (IC) devices may be faced with a hardware fault occurrence that may be caused by a variety of factors. For example, cosmic rays—which may include, for example, alpha, beta, or gamma radiation—impacting the IC device may cause unpredictable random hardware faults in the device. Electromagnetic or temperature spikes may also, for example, trigger hardware faults in the device. Hardware faults may occur, for example, in the form of flipped memory bits, flipped logic values, or timing errors. These faults may lead to data corruption, functional failure, or system crash, and may be indicative of physical damage to the device. Detecting and recovering from such faults is generally useful and is particularly important for devices in safety-critical systems such as, for example, vehicular (e.g., automotive) control systems.

### BRIEF DESCRIPTION OF THE DRAWINGS

Some examples of circuits, apparatuses and/or methods will be described in the following by way of example only. In this context, reference will be made to the accompanying Figures.

FIG. 1 illustrates an example computer-controlled system in accordance with some embodiments of the disclosure.

FIG. 2 illustrates a simplified schematic diagram of an example implementation of the IC device 100 of FIG. 1.

FIG. 3 illustrates a sequence diagram for an example fault response sequence for the IC device of FIG. 1 or the IC device of FIG. 2.

FIG. 4 illustrates a sequence diagram for an example fault response sequence for the IC device of FIG. 1 or the IC device of FIG. 2.

FIG. 5 is a flowchart of an example process in accordance with some embodiments of the disclosure, for performance by, for example, the IC device of FIG. 1 or the IC device of FIG. 2.

### DETAILED DESCRIPTION

The present disclosure will now be described with reference to the attached drawing figures, wherein like reference numerals are used to refer to like elements throughout, and wherein the illustrated structures and devices are not necessarily drawn to scale.

Many electrical systems include one or more integrated circuit devices. Each integrated circuit device may include a plurality of processing circuits. Certain electrical-system applications such as, for example, vehicle control, require a high level of operational integrity in order to ensure a desired level of safety. For example, a component of an Advanced Driver Assistance System (ADAS) may be assessed and assigned an Automotive Safety Integrity Level (ASIL) indicative of the component's ability to avoid and address failures of varying seriousness, where a higher ASIL level indicated an ability to meet higher safety requirements. Among the requirements for certain levels of safety are abilities to detect a failure, diagnose its source and extent, and determine and execute a response to resolve the failure. Software failures generally have a wider range of available responses than hardware failures.

In many conventional devices, hardware failures that are detected and diagnosed are then addressed by rebooting the device, which detrimentally interrupts the operation of the device, even in device with fast reboot times. Providing a greater flexibility in responding to hardware failures, particularly for multi-domain devices, would enable those devices to resolve hardware failures with fewer and lesser interruptions to their operations, thereby improving their performance. The domains of a multi-domain device are physical partitions of the device that are isolated to a degree from each other by having, for example, individually switchable and controllable power and clock sources, thereby making them individually rebootable.

In some embodiments, an integrated circuit (IC) device includes a root domain and a first branch domain. The root domain includes a logic circuit, a fault-structure circuit, a power delivery network (PDN) and a clock distribution network (CDN). The first branch domain includes a logic circuit, a fault-structure circuit, a PDN, and a CDN The PDN of the first branch domain is operable independently of the PDN of the root domain. The CDN of the first branch domain is operable independently of the CDN of the root domain. The fault-structure circuit of the first branch domain is configured to (1) detect a hardware fault occurrence in the first branch domain, (2) determine a response to the detected hardware fault occurrence, and (3) escalate the detected hardware fault occurrence to the fault-structure circuit of the root domain in accordance with the determined response. The fault-structure circuit of the root domain is configured to resolve the detected hardware fault occurrence escalated from the first branch domain. In this way, the fault-structure circuit in the root domain may be able to resolve the hardware fault in the first branch domain in ways that the first branch domain would not have been able to on its own.

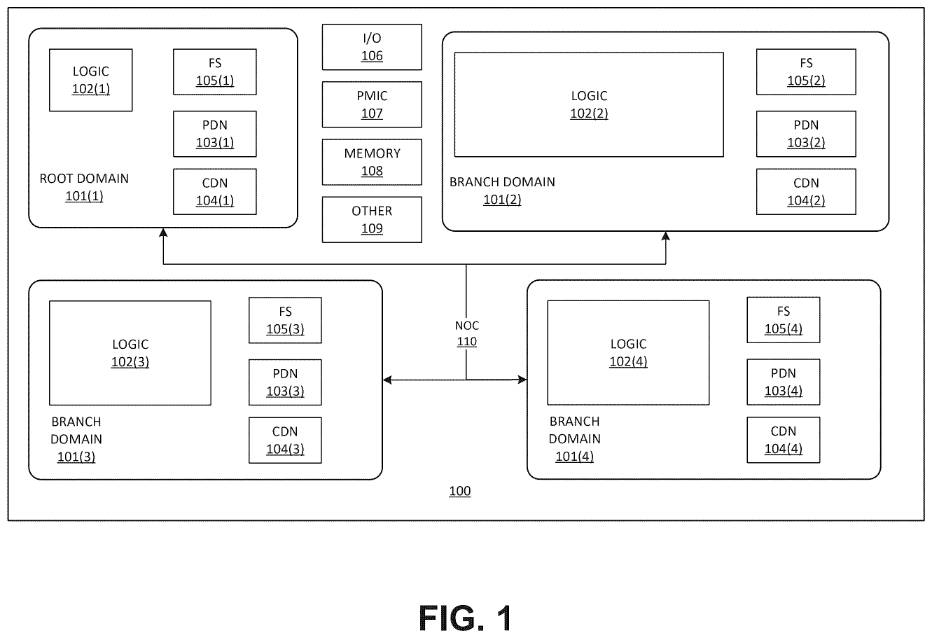

FIG. 1 illustrates a simplified schematic diagram of an example IC device 100 in accordance with some embodiments of the disclosure. The IC device 100, which may be a system on chip (SoC), comprises four domains 101, namely a root domain 101(1) and branch domains 101(2), 101(3), and 101(4). The root domain 101(1) is so called because it functions as the root of resiliency for the IC device 100, as will be described below. As the root of resiliency, it is configured to handle hardware failures in the branch domains. In some implementations, all of the domains 101 may be structurally identical. In some implementations, the root domain 101(1) may be designed to have a greater resiliency to random hardware failures.

The greater resiliency may be achieved by, for example, making the root domain 101(1) smaller in area than the branch domains 101(2)-(4). Having a smaller area inherently makes the root domain 101(1) less susceptible to failures caused by cosmic rays as there is less area for the cosmic rays to strike. Notably, a smaller area may also mean reduced operational capabilities for the root domain 101(1) compared to the branch domains 101(2)-(4). The root domain 101(1) may, alternatively or additionally, be hardened against hardware failures, where this hardening may be accomplished by, for example, varying its design or materials to make it more robust to hardware failures. The branch domains 101(2)-(4) may be substantially identical to each other or may also vary in terms of area, components, and functions.

The IC device 100 may comprise various other components such as, for example, an I/O module 106, a power management IC (PMIC) module 107, a memory (e.g., random-access memory (RAM)) module 108, and other modules 109. The other modules 109 may include, for example, controllers for sensors, receivers, and/or transmitters. The domains 101 may be interconnected by a network on chip (NoC) 110 of the device 100, which may also interconnect other components of the device 100.

Each domain 101 includes a corresponding logic circuit 102, power delivery network (PDN) 103, clock distribution network (CDN), and fault-structure (FS) circuit 105.

A logic circuit 102 may comprise, for example, one or more hardware accelerators, one or more processors, one or more controllers, or any other suitable logic circuitry. Hardware accelerators may, for example, have one or more digital signal processors (DSPs), graphics processing units (GPUs), or neural processing units (NPUs). Processors may be in the form of, for example, microcontroller units (MCUs), microprocessor units (MPUs), or central processing units (CPUs).

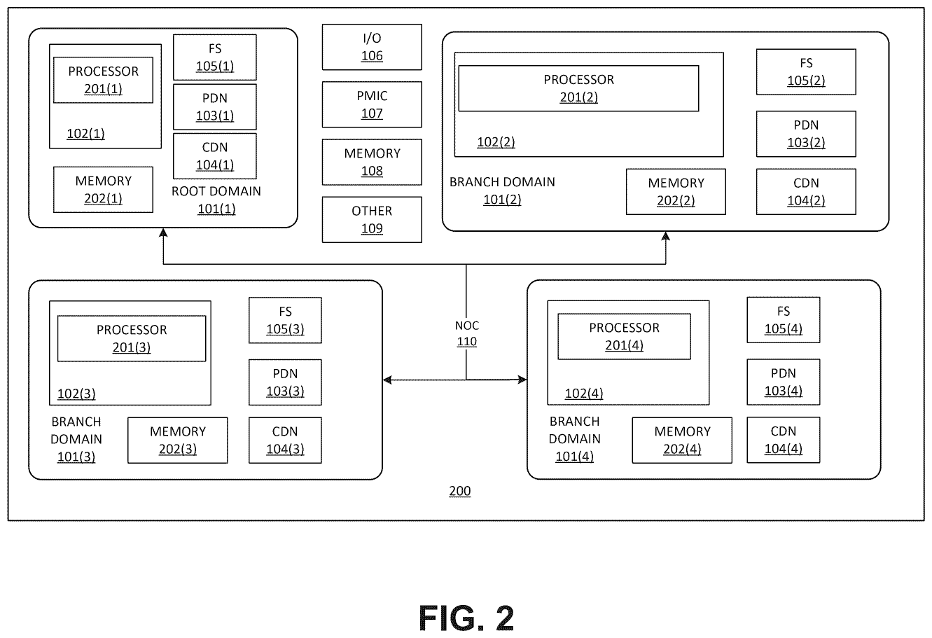

FIG. 2 illustrates a simplified schematic diagram of an example implementation 200 of the IC device 100 of FIG. 1. In implementation 200, each logic circuit 102 comprises a corresponding processor module 201. The processor module 201 may have one or more processing cores, which may be in the form of, for example, the above-mentioned MCUs, MPUs, or CPUs. In addition, in implementation 200, each domain also contains its own corresponding memory module 202, which may comprise, for example static RAM (SRAM).

The corresponding PDN 103 of each domain 101 is independently operable, thereby allowing any subset of domains 101 to be switched on or off without similarly switching the remaining domains 101. Each PDN 103 may be connected to the PMIC 107 to receive the power it then delivers to the components of the respective domain 101. A domain 101 may be rebooted by, for example, power cycling its corresponding PDN 103.

The corresponding CDN 104 of each domain 101 is independently controllable allowing any subset of domains 101 to receive, or be cut off from, a clock signal. Each CDN 104 may be connected to a shared clock source (not shown) of the device 100. Each CDN 104 may also include clock-adjusting circuitry—circuitry such as, for example, frequency dividers, frequency multipliers, phase-lock loops, and pulse-width modulators—to adjust the frequency, phase, duty cycle, or other characteristics of a received clock signal for distribution to one or more components of the respective domain 101. A domain 101 may be rebooted by, for example, power cycling its corresponding CDN 104.

The fault structure circuits 105 are configured to detect, diagnose, and respond to a variety of hardware faults. A hardware fault may trigger an interrupt that the corresponding fault-structure circuit 105 then attempts to handle. If the fault-structure circuit 105 of a branch domain 101(2)-(4) is unable to successfully resolve a detected fault on its own, then it escalates the fault to the fault-structure circuit 105(1) of the root domain 101(1). The escalation may also be in the form of an interrupt. The criteria for escalating, and whether to escalate, may be configurable at, for example, fabrication, by a retailer, and/or by a user. For example, a particular implementation of the device 100 might include one or more branch domains that do not escalate faults to a root domain. As another example, as described below, a branch domain may forgo escalating a fault unless a timer timeout occurs, where the timeout interval for the branch domain may be configurable, for example, at fabrication, by a retailer, and/or by a user.

The determination that a branch fault-structure circuit 105 is unable to successfully resolve a detected fault on its own may be made with the aid of a timer such as a watchdog timer or a local recovery timer. Specifically, the response to the detected hardware fault occurrence may include setting a watchdog timer, where the branch fault-structure circuit 105 is configured to escalate the detected hardware fault occurrence to the root fault-structure circuit 105(1) in response to the expiry, or timeout, of the watchdog timer. The watchdog timer may be in the form of a clock-triggered counter, but may also be in the form of a comparator comparing a determined timer-expiry time value, or timeout interval, to a current time value without requiring a corresponding counter.

The fault-structure circuits 105 may incorporate parts or entireties of safety management units (SMUs), which manage behavior of microcontrollers in response to faults. The root fault-structure circuit 105(1) can perform its own diagnosis of the fault and may perform a programmable mitigation response. In other words, the response may be directed by a reconfigurable software routine, table, data structure, neural network, or other suitable means, which determines a mitigation action based on provided diagnosis parameters. This flexibility allows the root fault-structure circuit 105(1), in appropriate circumstances, to resolve the fault without having to resort to rebooting the entirety of the fault-generating branch domain. In addition, this flexibility allows for updating the response to an already known of diagnosis parameters or new diagnosis parameters. Diagnosis parameters may include information such as indications of the type of error, the hardware location of the error, associated programs, associated memory locations, timing information, environmental information, state information, and any other information that may be useful to determine an appropriate response to the fault. An appropriate response may be selecting a suitable interrupt service routine to handle an interrupt generated in response to the hardware fault occurrence.

Hardware faults occurrences may include, for example, lockstep, clock, interconnect, and memory fails. A lockstep fail may be indicated by a lockstep monitoring circuit. Lockstep monitoring is an important safety feature that uses an identical redundant, or checker, processing core to verify the operation of a primary, or master, processing core. Lockstep monitoring uses a lockstep comparator to compare the output of the master core with the output of the redundant core to detect errors in the primary core. If exactly one of the cores suffers a failure, then the comparator would detect different output values.

Notably, if both cores are synched and suffer a simultaneous failure, such as a common mode failure, then the comparator will not detect the failure. Accordingly, In order to reduce the likelihood of a common mode failure causing a false negative, or failure to detect a fault, the input to the redundant core and the output of the primary core are delayed by one or more (e.g., two) clock cycles so they operate slightly out of sync. Consequently, a transient event would impact the primary and redundant cores at different processing stages and resultant errors should by caught by the comparator.

In one implementation, the root processor module 201(1) is always operating in lockstep mode, where the output of every primary processor is compared to the output of a corresponding redundant processor. If the processor modules 201 of all of the branch domains 101(2)-(4) are also operating in lockstep mode, then the device 200 may be said to operate in lockstep symmetric mode. If, however, the processor modules 201 of at least some of the branch domains 101(2)-(4) are operating without lockstep monitoring, then the device 200 may be said to operate in lockstep asymmetric mode. The device 200 may operate in lockstep asymmetric mode, for example, in response to a fault that renders a primary or redundant processor unreliable, as part of a throttling response to avoid overheating, or to save power.

A clock error may be detected by a clock monitoring circuit that may monitor factors such as frequency, duty cycle, and consistency. An interconnect error may be detected by a bus control unit. A memory error may be detecting using error correction/detection codes (ECC/EDC) and corresponding modules such as, for example, memory protection units.

If a hardware fault occurrence is associated with a particular module of a branch domain, such as, for example, a particular failed processor of a plurality of processors, then the resolving of the fault by the root fault-structure circuitry 105(1) may comprise rebooting the one failed processor of the plurality of processors without rebooting the other processors of the plurality of processors. Similarly, if a hardware fault occurrence is in a module that is not a processor, the resolving of the fault by the root fault-structure circuitry 105(1) may comprise rebooting the one failed module of the plurality of modules without rebooting the other modules of the plurality of modules.

If, for example, the memory 202 comprises a plurality of elements and the hardware fault occurrence is in an element of the memory 202 and the hardware fault occurrence corresponds to an identifiable program using that element, then the resolving by the root domain may comprise resetting the identified program without resetting the first branch domain.

In some implementation, a domain 101 may include an alarm register (not shown) to indicate the setting of an alarm flag. As part of responding to a hardware fault occurrence, the fault-structure circuitry 105 sets an alarm flag in the alarm register, wherein the flag remains set until cleared by the corresponding fault-structure circuitry 105 of the corresponding domain 101 or by the root fault-structure circuitry 105(1) of the root domain 101(1).

It should be noted that, in some instances, in response to an escalation from the fault-structure circuitry 105 of a branch domain 101(2)-(4), the root fault-structure circuitry 105(1) determines to reset the corresponding branch domain 101(2)-(4). In some instances, the root fault-structure 105(1) may even determine to reset the entire device 100 in response to a hardware-fault occurrence escalation from one of the branch domains 101(2)-(4), where it cannot otherwise satisfactorily resolve the hardware fault. The root fault-structure circuitry 105(1) may also address a hardware fault by throttling the branch domains (e.g., reducing clock frequency or supply voltage level) or operating the device in a degraded mode (e.g., turning off some processing cores).

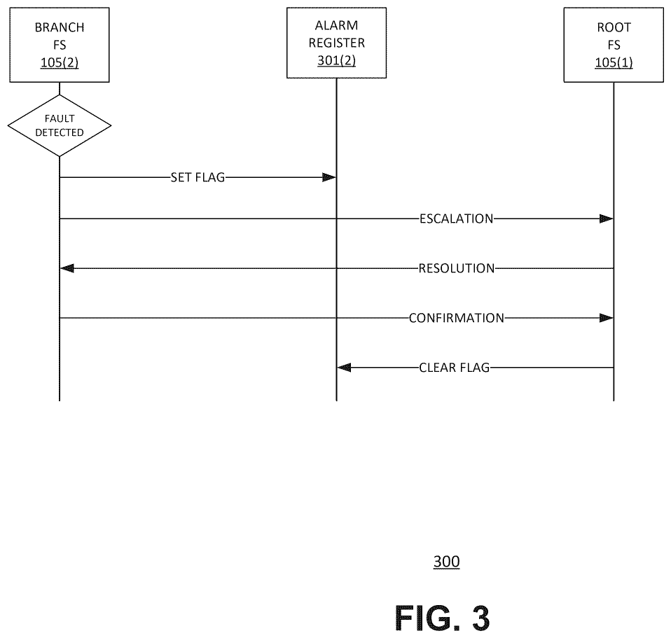

FIG. 3 illustrates a sequence diagram for an example fault response sequence 300 for the IC device 100 of FIG. 1 or the IC device 200 of FIG. 2. In the sequence 300, the detection of a hardware fault occurrence in domain 101(2) triggers the branch fault-structure circuit 105(2) to set an alarm flag in an alarm register 301(2) of the domain 101(2) and subsequently escalate the fault to the root fault-structure circuit 105(1), which proceeds to resolve the fault and send a resolution notification to the branch fault-structure circuit 105(2). Presuming the fault was indeed successfully resolved, the branch fault-structure circuit 105(2) sends a confirmation notification to the root fault-structure circuit 105(1), which then proceeds to clear the alarm flag in the alarm register 301(2).

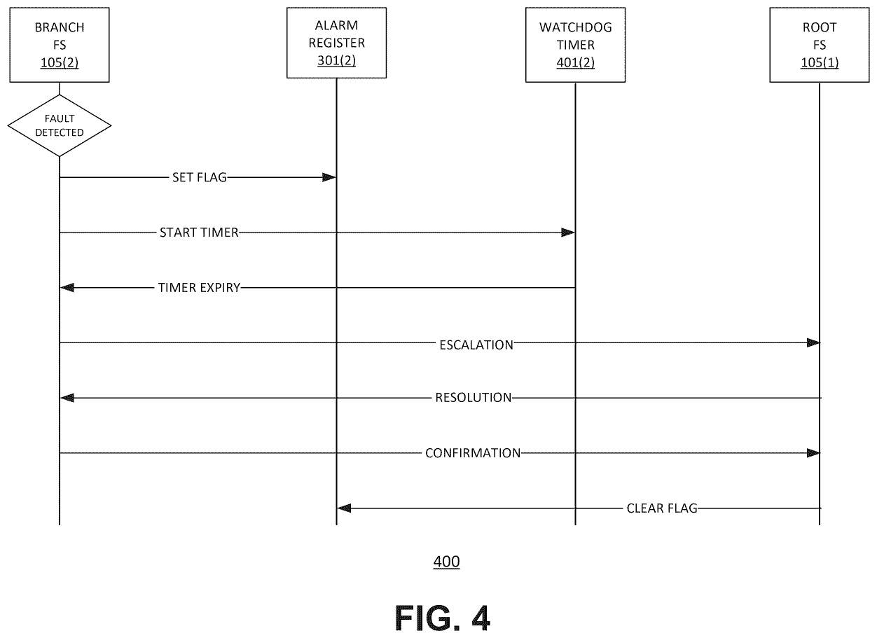

FIG. 4 illustrates a sequence diagram for an example fault response sequence 400 for the IC device 100 of FIG. 1 or the IC device 200 of FIG. 2. In the sequence 400, the detection of a hardware fault occurrence in domain 101(2) triggers the branch fault-structure circuit 105(2) to set an alarm flag in an alarm register 301(2) of the domain 101(2) and start a watchdog timer 401(2) of the domain 101(2). If the fault-structure circuit 105(2) fails to resolve the hardware fault and clear the watchdog timer 401(2) before the expiry of the watchdog timer 401(2), then the watchdog timer 401(2) sends an expiry notification to the fault-structure circuit 105(2), which, in turn, escalates the fault to the root fault-structure circuit 105(1). The root fault-structure circuit 105(1) proceeds to resolve the fault and send a resolution notification to the branch fault-structure circuit 105(2). Presuming the fault was indeed successfully resolved, the branch fault-structure circuit 105(2) sends a confirmation notification to the root fault-structure circuit 105(1), which then proceeds to clear the alarm flag in the alarm register 301(2). It should be noted that if, for example, the branch fault-structure circuit 105(2) resolves the hardware fault, then it clears the alarm flag itself and the steps involving the root fault-structure circuit 105(1) are skipped. It should also be noted that some implementations may forgo the sending of a confirmation notification and have the root fault-structure circuit 105(1) clear the alarm flag as part of the fault resolution. Alternatively, the branch fault-structure circuit 105(2) itself may clear the alarm flag following resolution of the hardware fault.

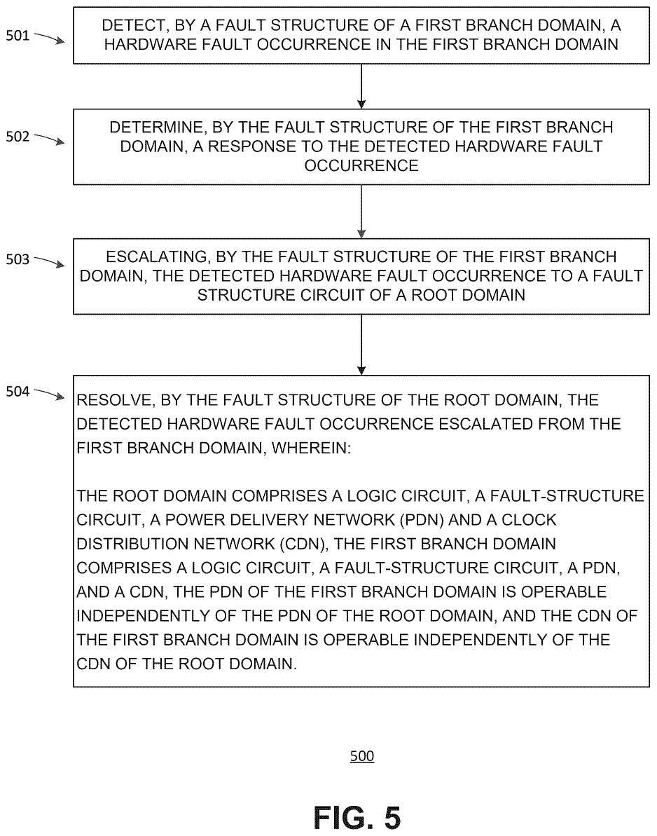

FIG. 5 illustrates a flowchart of an example process 500, in accordance with some embodiments of the disclosure, for performance by, for example, an IC device 100 of FIG. 1 or an IC device 200 of FIG. 2. The process 500 starts with step 501, which is to detect, by a fault structure of a first branch domain, a hardware fault occurrence in the first branch domain. The process continues with step 502, which is to determine, by the fault structure of the first branch domain, a response to the detected hardware fault occurrence.

Subsequently, step 503 is to escalate, by the fault structure of the first branch domain, the detected hardware fault occurrence to a fault structure circuit of a root domain. The process then proceeds with step 504, which is to resolve, by the fault structure of the root domain, the detected hardware fault occurrence escalated from the first branch domain, wherein: (1) the root domain comprises a logic circuit, a fault-structure circuit, a power delivery network (PDN) and a clock distribution network (CDN), (2) the first branch domain comprises a logic circuit, a fault-structure circuit, a PDN, and a CDN, (3) the PDN of the first branch domain is operable independently of the PDN of the root domain, and (4) the CDN of the first branch domain is operable independently of the CDN of the root domain. It should be noted that various alternatives, such as, for example, those described above in reference to process 400 of FIG. 4, are available for the process 500.

While embodiments have been illustrated and described with respect to one or more implementations, alterations and/or modifications may be made to the illustrated examples without departing from the spirit and scope of the appended claims. In particular regard to the various functions performed by the above described components or structures (assemblies, devices, circuits, circuitries, systems, etc.), the terms used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations.

Examples can include subject matter such as a method, means for performing acts or blocks of the method, at least one machine-readable medium including instructions that, when performed by a machine cause the machine to perform acts of the method or of an apparatus or system for detecting a non-transmitting target according to embodiments and examples described herein.

Example 1 is an integrated circuit (IC) device including a root domain having a logic circuit, a fault-structure circuit, a power delivery network (PDN) and a clock distribution network (CDN) and a first branch domain having a logic circuit, a fault-structure circuit, a PDN, and a CDN. The PDN of the first branch domain is operable independently of the PDN of the root domain. The CDN of the first branch domain is operable independently of the CDN of the root domain. The fault-structure circuit of the first branch domain is configured to: detect a hardware fault occurrence in the first branch domain, determine a response to the detected hardware fault occurrence, and escalate the detected hardware fault occurrence to the fault-structure circuit of the root domain in accordance with the determined response. The fault-structure circuit of the root domain is configured to resolve the detected hardware fault occurrence escalated from the first branch domain.

Example 2 includes the subject matter of example 1, including or omitting optional elements, wherein domain resiliency is resiliency to random hardware failures, the root domain is characterized by a root resiliency, the first branch domain is characterized by a first-branch resiliency and the root resiliency is greater than the branch resiliency.

Example 3 includes the subject matter of example 2, including or omitting optional elements, wherein domain resiliency is inversely correlated to domain area, the root domain is characterized by an area, the first branch domain is characterized by an area, and the area of the root domain is smaller than the area of the first branch domain.

Example 4 includes the subject matter of any one of examples 1-3, including or omitting optional elements, wherein the hardware fault occurrence is characterized as one of a lockstep fail, a clock fail, and an interconnect fail.

Example 5 includes the subject matter of any one of example 1-4, including or omitting optional elements, wherein the logic circuit of the first branch domain incudes one or more processors.

Example 6 includes the subject matter of example 5, including or omitting optional elements, wherein the one or more processors of the first branch domain includes a plurality of processors, the hardware fault occurrence is associated with only one failed processor of the plurality of processors, and the resolving by the root domain includes rebooting the one failed processor of the plurality of processors without rebooting the other processors of the plurality of processors.

Example 7 includes the subject matter of any one of examples 1-6, including or omitting optional elements, wherein the logic circuit of the first branch domain includes a hardware accelerator circuit.

Example 8 includes the subject matter of any one of examples 1-7, including or omitting optional elements, wherein the root domain operates with lockstep monitoring and the first branch domain operates without lockstep monitoring.

Example 9 includes the subject matter of any one of examples 1-8, including or omitting optional elements, wherein: (1) each additional branch domain includes a logic circuit, a fault-structure circuit, a PDN, and a CDN, (2) the PDN of each additional branch domain is operable independently of the PDNs of the root domain, the first branch domain, and the other additional branch domains, (3) the CDN of each additional branch domain is operable independently of the CDNs of the root domain, the first branch domain, and the other additional branch domains, (4) the fault-structure circuit of each additional branch domain is configured to: detect a hardware fault occurrence in the additional branch domain, determine a response to the detected hardware fault occurrence, and escalate the detected hardware fault occurrence to the fault-structure circuit of the root domain in accordance with the determined response, and (5) the fault-structure circuit of the root domain is configured to resolve the detected hardware fault occurrence escalated from the additional branch domain.

Example 10 includes the subject matter of any one of examples 1-9, including or omitting optional elements, wherein: the logic circuit of the first branch domain includes a plurality of modules, the hardware fault occurrence is in one module of the plurality of modules, and the resolving by the root domain includes resetting the one module of the plurality of modules without resetting the other modules of the plurality of modules.

Example 11 includes the subject matter of any one of examples 1-10, including or omitting optional elements, wherein: the first branch domain further includes a memory having elements, the hardware fault occurrence is in an element of the memory, wherein the hardware fault occurrence corresponds to a program using the element of the memory, and the resolving by the root domain includes resetting the program without resetting the first branch domain.

Example 12 includes the subject matter of any one of examples 1-11, including or omitting optional elements, wherein the resolving by the root domain includes rebooting the first branch domain without rebooting the device.

Example 13 includes the subject matter of example 12, including or omitting optional elements, wherein the rebooting includes power cycling the first branch domain using at least one of the PDN of the first branch domain and the CDN of the first branch domain.

Example 14 includes the subject matter of any one of examples 1-13, including or omitting optional elements, wherein: the device is a system on chip, the device further includes a network on chip (NoC), and the root domain and first branch are interconnected by the NoC.

Example 15 includes the subject matter of any one of examples 1-14, including or omitting optional elements, wherein: the first branch domain further includes an alarm register, the response to the detected hardware fault occurrence includes setting an alarm flag in the alarm register, and the resolving by the root domain includes clearing the alarm flag in the alarm register.

Example 16 includes the subject matter of any one of examples 1-15, including or omitting optional elements, wherein: the first branch domain further includes a watchdog timer, the response to the detected hardware fault occurrence includes setting the watchdog timer, and the fault-structure circuit of the first branch domain is configured to escalate the detected hardware fault occurrence to the fault-structure circuit of the root domain in response to an expiry of the watchdog timer.

Example 17 is a method including: (1) detecting, by a fault structure of a first branch domain, a hardware fault occurrence in the first branch domain, (2) determining, by the fault structure of the first branch domain, a response to the detected hardware fault occurrence, (3) escalating, by the fault structure of the first branch domain, the detected hardware fault occurrence to a fault structure circuit of a root domain, and (4) resolving, by the fault structure of the root domain, the detected hardware fault occurrence escalated from the first branch domain, wherein: (a) the root domain includes a logic circuit, a fault-structure circuit, a power delivery network (PDN) and a clock distribution network (CDN), (b) the first branch domain includes a logic circuit, a fault-structure circuit, a PDN, and a CDN, (c) the PDN of the first branch domain is operable independently of the PDN of the root domain, and (d) the CDN of the first branch domain is operable independently of the CDN of the root domain.

Example 18 includes the subject matter of example 17, including or omitting optional elements, wherein: the logic circuit of the first branch domain includes a plurality of modules, the hardware fault occurrence is in one module of the plurality of modules, and the resolving by the root domain includes resetting the one module of the plurality of modules without resetting the other modules of the plurality of modules.

Example 19 includes the subject matter of any one of examples 17-18, including or omitting optional elements, wherein the response to the detected hardware fault occurrence includes setting a watchdog timer and the escalating of the detected hardware fault occurrence to the fault structure of the root domain is in response to an expiry of the watchdog timer.

Example 20 is a non-transient computer-readable medium having instructions that, when executed, are configured to cause: detecting, by a fault structure of a first branch domain, a hardware fault occurrence in the first branch domain; determining, by the fault structure of the first branch domain, a response to the detected hardware fault occurrence, escalating, by the fault structure of the first branch domain, the detected hardware fault occurrence to a fault structure circuit of a root domain, and resolving, by the fault structure of the root domain, the detected hardware fault occurrence escalated from the first branch domain.

The foregoing description of one or more implementations provides illustration and description, but is not intended to be exhaustive or to limit the scope of the example embodiments to the precise form disclosed. Modifications and variations are possible in light of the above teachings or may be acquired from practice of various implementations of the example embodiments.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In the present disclosure like reference numerals are used to refer to like elements throughout, and wherein the illustrated structures and devices are not necessarily drawn to scale.

As utilized herein, terms “module”, “component,” “system,” “circuit,” “circuitry,” “element,” and the like are intended to refer to a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuitries can reside within a process, and circuitry can be localized on one computer and/or distributed between two or more computers. A set of elements or a set of other circuitry can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include field gates, logical components, hardware encoded logic, register transfer logic, one or more processors therein to execute software and/or firmware that confer(s), at least in part, the functionality of the electronic components.

It will be understood that when an element is referred to as being “electrically connected” or “electrically coupled” to another element, it can be physically connected or coupled to the other element such that current and/or electromagnetic radiation can flow along a conductive path formed by the elements. Intervening conductive, inductive, or capacitive elements may be present between the element and the other element when the elements are described as being electrically coupled or connected to one another. Further, when electrically coupled or connected to one another, one element may be capable of inducing a voltage or current flow or propagation of an electro-magnetic wave in the other element without physical contact or intervening components. Further, when a voltage, current, or signal is referred to as being “applied” to an element, the voltage, current, or signal may be conducted to the element by way of a physical connection or by way of capacitive, electro-magnetic, or inductive coupling that does not involve a physical connection.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

1. An integrated circuit (IC) device comprising:
a root domain comprising a logic circuit, a fault-structure circuit, a power delivery network (PDN) and a clock distribution network (CDN); and
a first branch domain comprising a logic circuit, a fault-structure circuit, a PDN, and a CDN, wherein:
the PDN of the first branch domain is operable independently of the PDN of the root domain;
the CDN of the first branch domain is operable independently of the CDN of the root domain;
the fault-structure circuit of the first branch domain is configured to:
detect a hardware fault occurrence in the first branch domain;
determine a response to the detected hardware fault occurrence; and
escalate the detected hardware fault occurrence to the fault-structure circuit of the root domain in accordance with the determined response; and
the fault-structure circuit of the root domain is configured to resolve the detected hardware fault occurrence escalated from the first branch domain.

2. The device of claim 1, wherein:
a domain resiliency is resiliency to random hardware failures;
the root domain is characterized by a root resiliency;
the first branch domain is characterized by a first-branch resiliency; and
the root resiliency is greater than the first-branch resiliency.

3. The device of claim 2, wherein:
the domain resiliency is inversely correlated to an area of the corresponding domain;
the root domain is characterized by an area;
the first branch domain is characterized by an area; and
the area of the root domain is smaller than the area of the first branch domain.

4. The device of claim 1, wherein the hardware fault occurrence is characterized as one of a lockstep fail, a clock fail, or an interconnect fail.

5. The device of claim 1, wherein the logic circuit of the first branch domain comprises one or more processors.

6. The device of claim 5, wherein:
the logic circuit of the first branch domain comprises a plurality of processors;
the hardware fault occurrence is associated with only one failed processor of the plurality of processors; and
the resolving by the root domain comprises rebooting the one failed processor of the plurality of processors without rebooting the other processors of the plurality of processors.

7. The device of claim 1, wherein the logic circuit of the first branch domain comprises a hardware accelerator circuit.

8. The device of claim 1, wherein the device is configured to operate in a lockstep asymmetric mode wherein:
the root domain operates with lockstep monitoring; and
the first branch domain operates without lockstep monitoring.

9. The device of claim 1, further comprising a set of one or more additional branch domains, wherein:
each additional branch domain comprises a logic circuit, a fault-structure circuit, a PDN, and a CDN;
the PDN of each additional branch domain is operable independently of the PDNs of the root domain, the first branch domain, and the other additional branch domains;
the CDN of each additional branch domain is operable independently of the CDNs of the root domain, the first branch domain, and the other additional branch domains;
the fault-structure circuit of each additional branch domain is configured to:
detect a hardware fault occurrence in the additional branch domain;
determine a response to the detected hardware fault occurrence; and
escalate the detected hardware fault occurrence to the fault-structure circuit of the root domain in accordance with the determined response; and
the fault-structure circuit of the root domain is configured to resolve the detected hardware fault occurrence escalated from the additional branch domain.

10. The device of claim 1, wherein:
the logic circuit of the first branch domain comprises a plurality of modules;
the hardware fault occurrence is in one module of the plurality of modules; and
the resolving by the root domain comprises resetting the one module of the plurality of modules without resetting the other modules of the plurality of modules.

11. The device of claim 1, wherein:
the first branch domain further comprises a memory comprising elements;
the hardware fault occurrence is in an element of the memory, wherein the hardware fault occurrence corresponds to a program using the element of the memory; and
the resolving by the root domain comprises resetting the program without resetting the first branch domain.

12. The device of claim 1, wherein the resolving by the root domain comprises rebooting the first branch domain without rebooting the device.

13. The device of claim 12, wherein the rebooting comprises power cycling the first branch domain using at least one of the PDN of the first branch domain and the CDN of the first branch domain.

14. The device of claim 1, wherein:
the device is a system on chip;
the device further comprises a network on chip (NoC); and
the root domain and first branch are interconnected by the NoC.

15. The device of claim 1, wherein:
the first branch domain further comprises an alarm register;
the response to the detected hardware fault occurrence includes setting an alarm flag in the alarm register; and
the resolving by the root domain comprises clearing the alarm flag in the alarm register.

16. The device of claim 1, wherein:
the first branch domain further comprises a watchdog timer;
the response to the detected hardware fault occurrence includes setting the watchdog timer; and
the fault-structure circuit of the first branch domain is configured to escalate the detected hardware fault occurrence to the fault-structure circuit of the root domain in response to an expiry of the watchdog timer.

17. A method comprising:
detecting, by a fault structure of a first branch domain, a hardware fault occurrence in the first branch domain;
determining, by the fault structure of the first branch domain, a response to the detected hardware fault occurrence;
escalating, by the fault structure of the first branch domain, the detected hardware fault occurrence to a fault structure circuit of a root domain; and
resolving, by the fault structure of the root domain, the detected hardware fault occurrence escalated from the first branch domain, wherein:
the root domain comprises a logic circuit, a fault-structure circuit, a power delivery network (PDN) and a clock distribution network (CDN);
the first branch domain comprises a logic circuit, a fault-structure circuit, a PDN, and a CDN;
the PDN of the first branch domain is operable independently of the PDN of the root domain; and
the CDN of the first branch domain is operable independently of the CDN of the root domain.

18. The method of claim 17, wherein:
the logic circuit of the first branch domain comprises a plurality of modules;
the hardware fault occurrence is in one module of the plurality of modules; and
the resolving by the root domain comprises resetting the one module of the plurality of modules without resetting the other modules of the plurality of modules.

19. The method of claim 17, wherein:
the response to the detected hardware fault occurrence includes setting a watchdog timer; and
the escalating of the detected hardware fault occurrence to the fault structure of the root domain is in response to an expiry of the watchdog timer.

20. A non-transient computer-readable medium comprising instructions that, when executed, are configured to cause:
detecting, by a fault structure of a first branch domain, a hardware fault occurrence in the first branch domain;
determining, by the fault structure of the first branch domain, a response to the detected hardware fault occurrence;
escalating, by the fault structure of the first branch domain, the detected hardware fault occurrence to a fault structure circuit of a root domain; and
resolving, by the fault structure of the root domain, the detected hardware fault occurrence escalated from the first branch domain.
